(19) United States
(12) Patent Application Publication
(10) Pub. No.: US 2011/0042482 A1
(43) Pub. Date: Feb. 24, 2011

(54) FOG GENERATOR HAVING AN IMPROVED HEAT EXCHANGER

(75) Inventor: Alfons Vandoninck, Opglabbeek (BE)

Correspondence Address: FISH & RICHARDSON P.C. (NY), P.O. BOX 1022, MINNEAPOLIS, MN, 55440-1022, US

(73) Assignee: BANDIT N.V., Opglabbeek (BE)

(21) Appl. No.: 12/791,295

(22) Filed: Jun. 1, 2010

(30) Foreign Application Priority Data
Jun. 2, 2009 (EP) 09161690.4

(51) Int. Cl. B05B 1/24

(52) U.S. Cl. 239/136

(57) ABSTRACT

The present invention relates to a fog generator comprising a heat exchanger for transforming a fog generating fluid into its vapor, characterized in that the fog generator further comprises a latent heat of fusion accumulator.

### FIELD OF THE INVENTION

The present invention relates to a device for generating fog.

### BACKGROUND OF THE INVENTION

Fog generators are used in a variety of applications. They can be used in applications concerning security, e.g. for generating a fog screen by which goods or valuables are screened out from the intruder's sight, or for simulating fire as a training aid for emergency services or security forces. They can also be used in applications concerning entertainment, e.g. for creating lighting effects on stage, etc.

According to the state of the art, a main working principle of a fog generator is as follows: a fog generating fluid is driven into a heat exchanger by a pump or a propellant gas; in the heat exchanger, the fog generating fluid is heated and transferred into its vapor; the vapor is ejected then at the end of the heat exchanger in the form of a fog into the ambient.

As known by the skilled person, the energy required for generating fog from a fog fluid is defined by:
the specific heat: energy per unit quantity needed to heat up the fog fluid from about from room temperature to vaporization temperature, which is dependent on the composition of the fog fluid, and
the latent heat of vaporization: energy needed to vaporize the fog fluid.

A general problem in the state-of-the-art is that in particular fog generators for security applications have to be able to deliver a very high amount of ejected fog per second. In other words, the fog ejection capacity of such fog generators needs to be sufficiently high to fill the office, store, container, etc. wherein the fog generator is installed as fast as possible with fog. As known by the skilled person, for security applications nowadays the fog ejection capacity is required to be at least in the range of 25 m³/s.

Because 1 ml fog fluid is sufficient to obscure about 1 m³ and because transforming 1 ml of a glycol and/or glycerol based fog fluid into ejected fog requires about 1000 Joules, a fog generator having a fog ejection capacity of about 25 m³/s vaporizes about 25 ml fog fluid per second and therefore requires a heat exchanger adapted to deliver about 25.000 J/s.

In attempt to solve the above problem, WO03092845 (MULTI MEDIA ELECTRONICS INC) describes a fog generator wherein the contact area on the heat exchanger heating plate could be corrugated to increase the area of contact between the surface of the heating plate and the fog fluid. However, the fog generator described inhere is mainly used in the entertainment business and is not able to meet the fog ejection capacity needed in for example security applications.

Obviously, another solution to the need for higher fog ejection capacity could be using more voluminous heat exchangers having more fog generation energy capacity. However, costumers clearly request for smaller fog generators because it is easier to hide them, both from a security as an esthetical point of view.

Further, more voluminous heat exchangers unavoidably suffer from increased energy losses due to thermal insulation losses compared to smaller ones, and also from increased installation weight, whereas legislation is limiting the fog generator installation weight.

Considering the above drawbacks, it is an object of the present invention to provide a fog generator having an increased fog ejection capacity while maintaining limited volume and limited weight.

Further, it is also an object of the present invention to keep the fog generator's energy consumption beneficial.

To meet the above objects the present invention provides a fog generator comprising a latent heat of fusion accumulator.

### SUMMARY OF THE INVENTION

The present invention is directed to a fog generator comprising a heat exchanger for transforming a fog generating fluid into its vapor, characterized in that the fog generator further comprises a latent heat of fusion accumulator.

### BRIEF DESCRIPTION OF THE DRAWINGS

FIG. 1 shows the heat exchanger of a fog generator in accordance with the present invention.

FIG. 2 illustrates the theoretical temperature behaviour of a fog generator in accordance with the present invention.

### DESCRIPTION OF THE INVENTION

According to a first embodiment of the present invention, a fog generator is provided comprising a heat exchanger for transforming a fog generating fluid into its vapor, characterized in that the fog generator may further comprise a latent heat of fusion accumulator.

In the context of the present invention, a latent heat of fusion accumulator is essentially a latent heat storage medium, wherein latent heat is defined as the amount of energy in the form of heat released or absorbed by a substance during a change of phase state respectively from liquid to solid, or solid to liquid.

By implementing such latent heat of fusion accumulator in the fog generator, the fog ejection capacity may be increased significantly due to stored latent heat which is an extra source of fog generation energy during the exothermic phase change from liquid to solid.

Therefore, a fog generator comprising a latent heat of fusion accumulator will gain more fog generation energy and as a result a higher fog ejection capacity than a conventional fog generator.

The other way around, a conventional fog generator would need a more voluminous and heavier heat exchanger to deliver the same amount of fog generation energy and to have the same fog ejection capacity as a conventional fog generator.

Further, it has been found that during a fog generating cycle the ejected fog temperature maintains relatively stable for a longer period of time compared to the ejected fog temperature of conventional fog generators. Since a fog generator in accordance with the present invention is able to deliver an increased amount of fog generation energy compared to conventional fog generators, the temperature interval of the ejected fog may be kept relatively stable for a longer period of time.

In accordance with the invention, the latent heat of fusion accumulator may be part of the heat exchanger or may be implemented in the fog generator at the beginning or at the end of the heat exchanger channel. In both cases the latent heat of fusion accumulator may provide extra fog generation energy via the heat exchanger body to the fog fluid, or may provide extra fog generation directly to the fog fluid.

In an embodiment of the present invention, a fog generator is provided wherein the latent heat of fusion accumulator may be installed in the heat exchanger.

By integrating a latent heat of fusion accumulator in the heat exchanger, the assembly of heat exchanger and accumulator may have a lower volume and/or lower weight than a heat exchanger able to store the same amount of fog generation energy without accumulator. Consequently, the fog generator as a whole may be smaller and may have a lower weight than a conventional fog generator with the same fog ejection capacity.

Further, the limited volume of the heat exchanger and the fact that the latent heat of fusion accumulator is installed within the heat exchanger may result in less energy losses due to thermal insulation energy losses, which makes the fog generator energetically beneficial.

In a further embodiment in accordance with the invention, the latent heat of fusion accumulator may comprise at least one cavity containing a phase change material within the heat exchanger body. The phase change material may also be located in several cavities in several locations within the heat exchanger body. The form of the one or more cavities may be spherical, cubical, rod-like, spiral, or may have any other form fitting in the heat exchanger body.

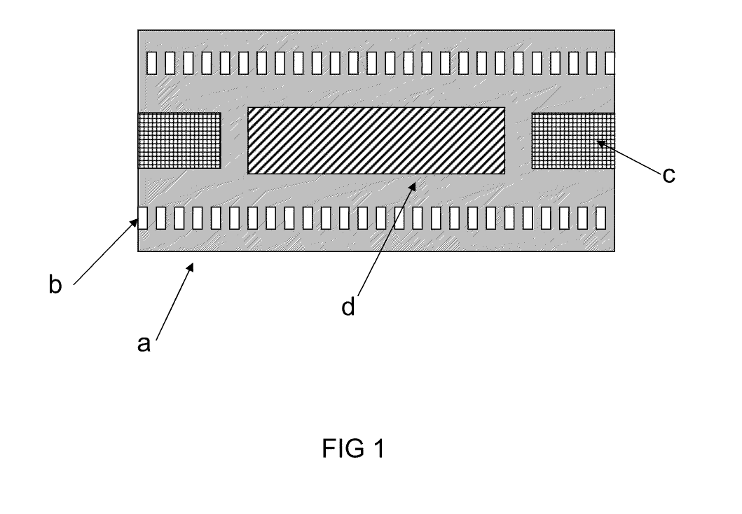

In a preferred embodiment in accordance with the present invention, a fog generator is provided wherein the heat exchanger, as illustrated schematically in cross-section in FIG. 1, comprises the following parts:
a solid metal body (a) (usually steel or aluminum) comprising one or more helix heat exchanger channels (b)
heating means (c), such as resistor or induction heating, usually with temperature sensing and/or regulating means
a cavity containing a phase change material (d), located in the center of the solid metal body and conducting its stored specific and latent energy via the metal body to the flowing fog fluid present in the heat exchanger channel(s).

The liquid-solid phase change material may comprise any material which may be used as a latent energy source by exothermically changing its phase from liquid into solid. In practice it may be selected based on:
the optimal vaporization temperature of the fog fluid used
the optimal ratio between the volume of phase change material and its fusion energy, such that as much as possible energy is stored in as less as possible volume of molten phase change material
the thermal conductivity of the molten phase change material
the corrosive and diffusion properties of the phase change material.

Preferably, the liquid-solid phase change material may comprise at least one of the group of non-ferro metals, or of the group of nitrate salts, chloride salts and the like, or a mixture thereof.

Even more preferably, the non-ferro metal may comprise zinc or zinc alloys, such as zamak. Zinc or zinc alloys meet the above selection criteria in terms of fusion temperature, thermal conductivity, ratio between stored fusion energy and volume, less reactive and less diffusive in the heat exchanger metal body. Additionally, it does not contain lead and may be considered as non-toxic.

Since in accordance with the present invention a glycol and/or glycerol based fog fluid may be used which has an optimal vaporization temperature of between about 200° C. and 450° C., preferably between about 250° C. and 430° C., and even more preferably between about 350° C. and 390° C., a fog generator may be provided wherein the fusion temperature of the liquid-solid phase change material is between 200° C. and 450° C., preferably between about 250° C. and 430° C., and even more preferably between about 350° C. and 390° C., wherein the fusion temperature of the phase change material should be higher than the optimal vaporization temperature of the fog fluid.

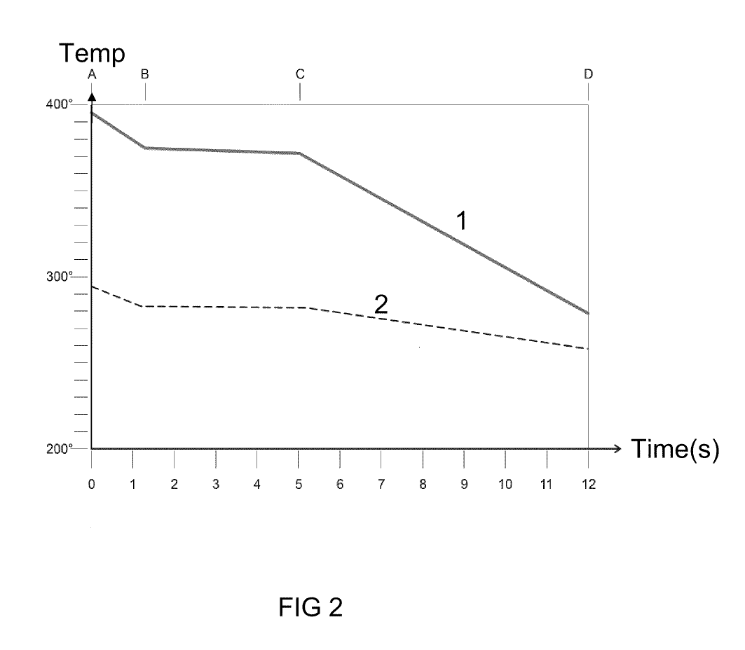

Theoretically, the temperature behaviour of a fog generator according to the present invention may be as illustrated in FIG. 2:
Curve 1 is the temperature behaviour of the heat exchanger comprising a latent heat of fusion accumulator
Curve 2 is the temperature behaviour of the ejected fog immediately after leaving the heat exchanger channel(s).
In zone AB the specific heat of both the heat exchanger body and molten phase change material is consumed to vaporize fog fluid, such that the heat exchanger temperature decrease significantly for each vaporized ml of fog fluid.
In zone BC mainly latent heat of the latent heat of fusion accumulator is used to vaporize fog fluid, such that the heat exchanger temperature does not decrease significantly.
In zone CD specific heat of both the heat exchanger body and solidified phase change material is consumed to vaporize fog fluid, such that the heat exchanger temperature decrease significantly.

In conventional fog generators generally the temperature behaviour of the ejected fog follows more or less the behaviour of the heat exchanger temperature, but its temperature interval between the start and the end of a fog generation period is smaller than the heat exchanger temperature interval. As known by the skilled person, this is due to the fact that (a) flog fluid absorbs thermal energy much more easily than vaporized fog fluid, and (b) the velocity of the fog in the heat exchanger channel is that high that the fog is not able to absorb significantly more energy than needed for vaporization. In case of a fog generator in accordance with the present invention, the relatively small temperature interval of the ejected fog may be kept longer, i.e. maintains more stable, due to the increased available amount of fog generation energy. As an example, for such fog generator the ejected fog temperature may decrease only about 30° C. in a fog generation period of 12 s.

The fog fluid flow in a heat exchanger according to the present invention may be above about 5 ml/s, above about 10 ml/s, above about 20 ml/s, or even about 30 ml/s depending on its fog ejection capacity. The fog ejection capacity may be more than about 10 m³/s, more than about 20 m³/s, or even more than about 30 m³/s.

### Example

One considers a fog generator in accordance with the present invention with a heat exchanger comprising a 4000 g steel body and a cavity in the center of the body containing 1000 g zinc phase change material.

Since the specific heat of steel is 0.46 J/C.° g, the specific heat of zinc is 0.42 J/C.° g and the latent fusion heat of zinc is 110 J/g, and since the temperature interval between the fog generator stand-by temperature and the minimum temperature needed for efficient and high quality fog generation can be considered as about 100° C., the stored fog generation energy of the heat exchanger is:

(4000×0.46×100)+(1000×0.42×100)+(1000×110)

=226.000 J (specific heat)+110.000 J (latent heat)

=336.000 J

Consequently, 336.000 J/12 seconds fog generation=28.000 J/s.

Apparently, a fog generator with a heat exchanger comprising a 4000 g steel body and 1000 g zinc phase change material will gain 46% more fog generation energy and consequently will have more fog ejection capacity than a fog generator with a heat exchanger having a 5000 g steel body only.

The other way around, a fog generator would need a heat exchanger comprising a 7300 g steel body only to gain the same amount of fog generation energy and to have the same fog ejection capacity as a fog generator with a heat exchanger comprising a 4000 g steel body and 1000 g zinc phase change material.

1. A fog generator comprising a heat exchanger for transforming a fog generating fluid into its vapor,
characterized in that the fog generator further comprises a latent heat of fusion accumulator.

2. A fog generator according to claim 1, wherein the latent heat of fusion accumulator is integrated in the heat exchanger.

3. A fog generator according to claim 2, wherein the latent heat of fusion accumulator comprises at least one cavity containing a liquid-solid phase change material within the heat exchanger body.

4. A fog generator according to claim 3, wherein the liquid-solid phase change material comprises at least one of the group of non-ferro metals, or of the group of nitrate salts, chloride salts and the like, or a mixture thereof.

5. A fog generator according to claim 3, wherein the fusion temperature of the liquid-solid phase change material is between 200° C. and 450° C. and wherein the fusion temperature is higher than the optimal vaporization temperature of the fog generator's fog fluid.

6. A fog generator according to claim 4, wherein the fusion temperature of the liquid-solid phase change material is between 200° C. and 450° C. and wherein the fusion temperature is higher than the optimal vaporization temperature of the fog generator's fog fluid.

7. A fog generator according to claim 5, wherein the non-ferro metal comprises zinc or zinc alloys.

8. A fog generator according to claim 6, wherein the non-ferro metal comprises zinc or zinc alloys.

9. A fog generator according to claim 1, wherein the fog fluid flow through the heat exchanger is above 5 ml/s.
